(19) United States
(12) Patent Application Publication
(10) Pub. No.: US 2006/0293028 A1
(43) Pub. Date: Dec. 28, 2006

(54) Techniques to manage network authentication

(76) Inventors: Uma M. Gadamsetty, Chandler, AZ (US); Ramgopal K. Reddy, Portland, OR (US)

Correspondence Address: KACVINSKY LLC;C/O INTELLEVATES, P.O. BOX 52050, MINNEAPOLIS, MN, 55402, US

(21) Appl. No.: 11/167,993

(22) Filed: Jun. 27, 2005

(51) Int. Cl. H04M 1/66

(52) U.S. Cl. 455/411

(57) ABSTRACT

A system, apparatus, method and article to manage network authentication are described. The apparatus may include an authentication management module to manage authentication of a first mobile device to access a wireless local area network using subscriber information stored on a second mobile device. Other embodiments are described and claimed.

### BACKGROUND

A wireless device may be arranged to communicate information using a wireless medium, such as radio-frequency (RF) spectrum. In some cases, the operations needed to establish the connection over the wireless medium may be relatively complex. Techniques to reduce the complexity of managing wireless connections may facilitate use of the wireless device. Consequently, improvements in managing wireless connections may improve the use and performance of a wireless device or network.

### BRIEF DESCRIPTION OF THE DRAWINGS

FIG. 1 illustrates one embodiment of a media processing system.

FIG. 2 illustrates one embodiment of a media processing node.

FIG. 3 illustrates one embodiment of an authentication management module.

FIG. 4 illustrates one embodiment of an authentication management module.

FIG. 5 illustrates one embodiment of a logic diagram.

### DETAILED DESCRIPTION

Some embodiments may be directed to techniques to manage authentication for a network. Authentication may refer to the operations used to determine the identity of a user and whether the user is permitted access to network services. For example, a cellular radiotelephone network may authenticate a user of a mobile telephone prior to allowing the mobile telephone to access a wireless wide area network (WWAN). In another example, a wireless local area network (WLAN) may authenticate a user of a mobile device (e.g., a notebook) prior to allowing the mobile device to access the WLAN. Authentication operations typically use information or credentials related to a particular user or device, such as a name, identification number, account number, and so forth. Different networks may use different types of information, which may cause an administrative burden for the user. Accordingly, some embodiments may manage authentication information for use across multiple devices or networks.

Some embodiments enable the use of the Extensible Authentication Protocol with Subscriber Identity Module (EAP-SIM) authentication techniques to provide a user with the ability to roam between different wireless network types, such as a WLAN or wireless wide area network (WWAN), cross multiple locations using a single set of SIM credentials. In addition to a common authentication model, this technology also enables a single billing mechanism across heterogeneous wireless networks. The embodiments are not limited in this context.

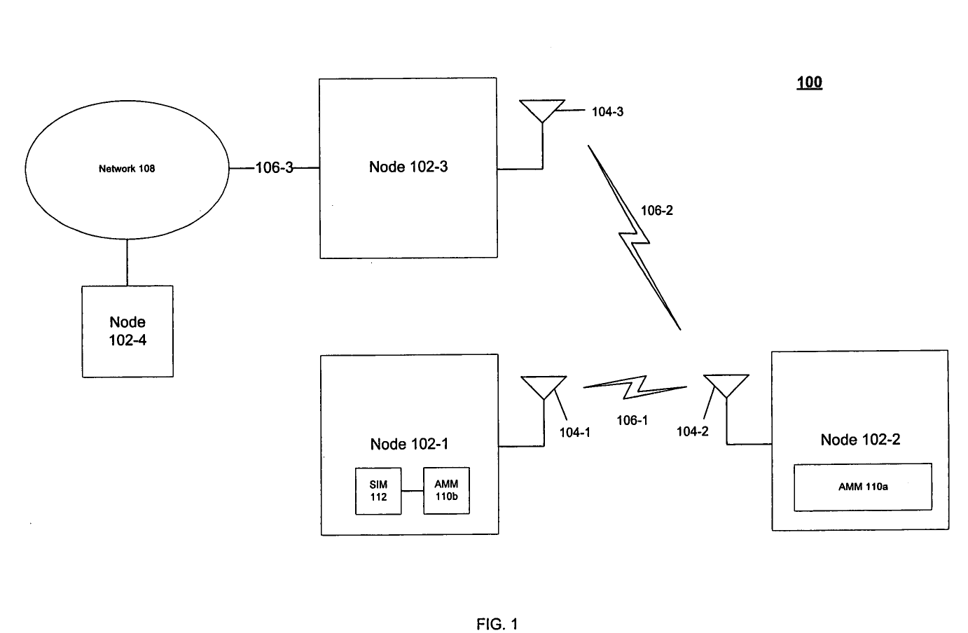

FIG. 1 illustrates one embodiment of a media processing system. FIG. 1 illustrates a block diagram of a media processing system 100 comprising multiple nodes. A node generally may comprise any physical or logical entity for communicating information in the system 100 and may be implemented as hardware, software, or any combination thereof, as desired for a given set of design parameters or performance constraints.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station, a radio network controller (RNC), a mobile home location register (HLR) as subscriber center, a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

In various embodiments system 100 may be implemented as a wired communication system, a wireless communication system, or a combination of both. Although system 100 may be illustrated using a particular communications media by way of example, it may be appreciated that the principles and techniques discussed herein may be implemented using any type of communication media and accompanying technology. The embodiments are not limited in this context.

When implemented as a wired system, for example, system 100 may include one or more nodes arranged to communicate information over one or more wired communications media. Examples of wired communications media may include a wire, cable, printed circuit board (PCB), backplane, switch fabric, semiconductor material, twisted-pair wire, co-axial cable, fiber optics, and so forth. The communications media may be connected to a node using an I/O adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), disc controller, video controller, audio controller, and so forth. The embodiments are not limited in this context.

When implemented as a wireless system, for example, system 100 may include one or more wireless nodes arranged to communicate information over one or more types of wireless communication media, sometimes referred to herein as wireless shared media. An example of a wireless communication media may include portions of a wireless spectrum, such as the RF spectrum. The wireless nodes may include components and interfaces suitable for communicating information signals over the designated wireless spectrum, such as one or more antennas, wireless transmitters/receivers (“transceivers”), amplifiers, filters, control logic, and so forth. The embodiments are not limited in this context.

Some embodiments may be directed to managing authentication operations for a wireless network, such as system 100. More particularly, the embodiments may attempt to manage authentication operations between a first mobile device and a network using information stored on a second mobile device. An example of a first mobile device may comprise a mobile computer, such as a notebook, handheld computer, or PDA. An example of a second mobile device may comprise a cellular telephone. An example of a network may comprise a WLAN. The embodiments, however, are not limited to these examples.

In one embodiment, for example, the first mobile device (e.g., a notebook computer) may attempt to access a WLAN via an AP. The AP may request subscriber information from the first mobile device to perform authentication operations prior to allowing the first mobile device to access the WLAN. Subscriber information may include any authentication information associated with a particular user or individual, such as an owner of the second mobile device (e.g., a cellular telephone). In one embodiment, for example, the subscriber information may be stored in a subscriber identity module (SIM). The SIM may normally allow the second mobile device to access a WWAN through the cellular radiotelephone network. In some embodiments, the first mobile device may use the SIM for the cellular telephone to authenticate the first mobile device in order to access a network other than the WWAN, such as a WLAN. To access the subscriber information stored in the SIM of the second mobile device, the first mobile device may form a secure connection with the second mobile device using various personal area network (PAN) techniques or near field communication techniques. The first mobile device may retrieve the subscriber information from the SIM of the second mobile device over the secure connection. The first mobile device may then use the subscriber information to complete the authentication operations with an AP for accessing the WLAN. The embodiments are not limited in this context.

In this manner, a user with a notebook computer may have access to communication services over the WLAN using subscriber information typically associated with the cellular telephone. The sharing of subscriber information across multiple devices may avoid the need for a user to have multiple accounts with a service provider, with each account associated with a different device, and with each account having a separate set of subscriber information. Rather, a single account may be established for the user with a single set of subscriber information, and a user may use the subscriber information to access different network services. The embodiments are not limited in this context.

In some embodiments the authentication operations may be managed by an authentication management module (AMM). In one embodiment, for example, the AMM may be arranged to automatically form a first connection between a first mobile device and a second mobile device, retrieve subscriber information from the second mobile device, and perform authentication operations over a second connection with a fixed device using the subscriber information stored by the second mobile device. The term “automatically” as used herein may refer to performing operations without user intervention or with limited user intervention. The embodiments are not limited in this context.

Referring again to FIG. 1, system 100 may include one or more nodes 102-1-n. Although FIG. 1 is shown with a limited number of nodes in a certain topology, it may be appreciated that system 100 may include more or less nodes in any type of topology as desired for a given implementation. The embodiments are not limited in this context.

In one embodiment, system 100 may include nodes 102-1, 102-2. Nodes 102-1, 102-2 may each comprise, for example, mobile devices having wireless capabilities. Examples for mobile devices 102-1, 102-2 may include a any of the examples provided for a node, such as a computer, server, workstation, notebook computer, handheld computer, telephone, cellular telephone, PDA, combination cellular telephone and PDA, pagers, and so forth as previously described. The embodiments are not limited in this context.

In one embodiment, for example, node 102-1 may comprise a cellular telephone. Although some embodiments may be described with mobile device 102-1 implemented as a cellular telephone by way of example, it may be appreciated that other embodiments may be implemented using other wireless devices as well. The embodiments are not limited in this context.

In one embodiment, mobile device 102-1 may comprise part of a cellular communication system. Examples of cellular communication systems may include Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) cellular radiotelephone systems, Extended-TDMA (E-TDMA) cellular radiotelephone systems, third generation (3G) systems such as Wide-band CDMA (WCDMA), CDMA-2000, Universal Mobile Telephone System (UMTS) cellular radiotelephone systems compliant with the Third-Generation Partnership Project (3GPP), and so forth. The embodiments are not limited in this context.

In addition to voice communication services, mobile device 102-1 may be arranged to communicate using a number of different WWAN data communication services. Examples of cellular data communication systems offering WWAN data communication services may include a GSM with General Packet Radio Service (GPRS) systems (GSM/GPRS), CDMA/1×RTT systems, Enhanced Data Rates for Global Evolution (EDGE) systems, and so forth. The embodiments are not limited in this respect.

In one embodiment, for example, mobile device 102-2 may comprise a notebook computer. Although some embodiments may be described with mobile device 102-2 implemented as a notebook computer by way of example, it may be appreciated that other embodiments may be implemented using other wireless devices as well. The embodiments are not limited in this context.

In one embodiment, mobile devices 102-1-3 may communicate information using wireless communications medium 106-1 and/or 106-2. Mobile devices 102-1-3 may each comprise a wireless transceiver and antennas 104-1-3, respectively. Examples for antennas 104-1-3 may include an internal antenna, an omni-directional antenna, a monopole antenna, a dipole antenna, an end fed antenna, a circularly polarized antenna, a micro-strip antenna, a diversity antenna, a dual antenna, an antenna array, a helical antenna, and so forth. Although mobile devices 102-1-3 are shown in FIG. 1 with single antennas 104-1-3, respectively, it may be appreciated that wireless devices 102-1-3 may also include multiple antennas. The use of multiple antennas may be used to provide a spatial division multiple access (SDMA) system or a multiple-input multiple-output (MIMO) system, for example. The embodiments are not limited in this context.

Communications between mobile devices 102-1, 102-2 may be performed in accordance with a number of wireless protocols. Examples of wireless protocols may include various WLAN protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may include various WWAN protocols, such as GSM cellular radiotelephone system protocols with GPRS, CDMA cellular radiotelephone communication systems with 1×RTT, EDGE systems, and so forth. Further examples of wireless protocols may include wireless PAN protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles (collectively referred to herein as “Bluetooth Specification”), and so forth. Yet another example of wireless protocols may include near-field communication techniques and protocols, such as electromagnetic induction (EMI) techniques. An example of EMI techniques may include passive or active radio-frequency identification (RFID) protocols and devices. Other suitable protocols may include Ultra Wide Band (UWB), Digital Office (DO), Digital Home, Trusted Platform Module (TPM), ZigBee, and other protocols. The embodiments are not limited in this context.

In one embodiment, for example, mobile devices 102-1, 102-2 may be arranged with the appropriate hardware, software and radio/air interfaces to communicate data using a wireless PAN technique or near-field communication technique. In one embodiment, for example, mobile devices 102-1, 102-2 may communicate using a wireless PAN technique such as Bluetooth. Although some embodiments may be described with mobile devices 102-1, 102-2 implemented as Bluetooth devices by way of example, it may be appreciated that other embodiments may be implemented using other wireless devices as well. The embodiments are not limited in this context.

In one embodiment, mobile device 102-1 may store subscriber information for a user. The subscriber information may comprise, for example, any type of information typically associated with the user. For example, the subscriber information may comprise International Mobile Subscriber Information (IMSI), which may include a subscriber name, an account number, a telephone number, subscription information, service provider information, billing information, and so forth. When the user attempts to use a communication service offered by a given communication services provider, the communications services provider may use the subscriber information to determine whether the user is authorized to use the requested service. Further, the communication services provider may use the subscriber information to authenticate the identity of the user prior to allowing access to the requested service. For example, mobile device 102-1 may use the subscriber information to authenticate mobile device 102-1 for access to a WWAN through the cellular radiotelephone system. The embodiments are not limited in this context.

In one embodiment, mobile device 102-1 may store the subscriber information using a SIM 112. SIM 112 may comprise a semiconductor device such as an integrated chip (IC) integrated with a smart card. A smart card may comprise, for example, a memory card having volatile or non-volatile memory resources. For example, SIM 112 may comprise a smart card inside a GSM cellular telephone that identifies the user account to the network, handles authentication and provides data storage for user data such as phone numbers and network information. Further, SIM 112 may also contain applications that run on the GSM cellular telephone as well as user stored data. In one embodiment, for example, SIM 112 may be implemented using a removable form factor that is capable of being inserted and withdrawn from a corresponding receiving interface slot built into mobile device 102-1. This allows SIM 112 to be moved between various mobile devices. Alternatively, SIM 112 may be permanently integrated with mobile device 102-1. The embodiments are not limited in this context.

In one embodiment, system 100 may include node 102-3. Node 102-3 may comprise, for example, a fixed station having wireless capabilities. Examples for node 102-3 may include a wireless AP, base station or node B, router, switch, hub, gateway, and so forth. In one embodiment, for example, node 102-3 may comprise an AP for a WLAN. Although some embodiments may be described with node 102-3 implemented as an AP by way of example, it may be appreciated that other embodiments may be implemented using other wireless devices as well. The embodiments are not limited in this context.

In one embodiment, system 100 may include network 108 connected to node 102-3 by wired communications medium 106-3. Network 108 may comprise additional nodes and connections to other networks, including a voice/data network such as the Public Switched Telephone Network (PSTN), a packet network such as the Internet, a LAN, a metropolitan area network (MAN), a WAN, an enterprise network, a private network, and so forth. The embodiments are not limited in this context.

In one embodiment, for example, network 108 may provide a connection to node 102-4. Node 102-4 may comprise, for example, a server, such as an authentication server for a network. An authentication server may authenticate a user device seeking access to network 108 via fixed device 102-3. One example of an authentication server may include an authentication, authorization and accounting (AAA) remote authentication dial-in user service (RADIUS) (AAA/RADIUS) authentication server, as defined in the IEEE documents titled “Remote Authentication Dial-in User Service (RADIUS),” RFC 2865, and “RADIUS Accounting,” RFC 2866, for example (the “RADIUS Specifications”). The RADIUS Specifications are used to provide authentication, authorization, and accounting services for a network. A RADIUS client such as a dial-up server, virtual private network (VPN) server, or a wireless AP may send user credentials and connection parameter information in the form of a RADIUS message to a RADIUS server (e.g., authentication server 102-4). The RADIUS server authenticates and authorizes the RADIUS client request, and sends back a RADIUS message response. RADIUS clients also send RADIUS accounting messages to RADIUS servers. Additionally, the RADIUS standards support the use of RADIUS proxies. A RADIUS proxy is a computer that forwards RADIUS messages between RADIUS-enabled computers. RADIUS messages are sent as User Datagram Protocol (UDP) messages. UDP port 1812 is used for RADIUS authentication messages and UDP port 1813 is used for RADIUS accounting messages. Some network access servers might use UDP port 1645 for RADIUS authentication messages and UDP port 1646 for RADIUS accounting messages. By default, Internet Authentication Service (IAS) supports receiving RADIUS messages destined to both sets of UDP ports. Only one RADIUS message is typically included in the UDP payload of a RADIUS packet.

In one embodiment, mobile devices 102-1, 102-2 may include authentication management modules (AMM) 110b, 110a, respectively. AMM 110a, 110b may be arranged to interactively manage authentication operations for mobile device 102-2. For example, AMM 110a may use smart card management techniques to retrieve subscriber information from SIM 112 via AMM 110b of mobile device 102-1. In other words, AMM 110b may cooperate with AMM 110a to retrieve the subscriber information from SIM 112.

In one embodiment, for example, AMM 110a, 110b may facilitate authentication operations between mobile device 102-2 (e.g., a notebook) and fixed station 102-3 (e.g., an AP) using subscriber information stored by mobile device 102-1 (e.g., a cellular telephone). For example, mobile device 102-2 may request access to a WLAN via fixed station 102-3 over wireless communications medium 106-2. Fixed station 102-3 may facilitate authentication operations on behalf of authentication server 102-4 to authenticate the identity of the user of mobile device 102-2. Mobile device 102-2 may establish a connection (e.g., a secure connection) between mobile devices 102-1, 102-2 using a PAN technique or near-field communication technique (e.g., Bluetooth). Mobile device 102-2 may use AMM 110a, 110b to retrieve the subscriber information from SIM 112 of mobile device 102-1 using the PAN connection. Mobile device 102-2 may use the subscriber information to complete the authentication operations with fixed station 102-3 via authentication server 102-4. In this manner, a user may use mobile device 102-1 to seamlessly perform authentication operations when accessing WLAN communication services via mobile device 102-2. This may reduce the number of communication provider service accounts a user may need to access different types of communication services. Consequently, AMM 110a, 110b may potentially improve performance of one or more nodes 102-1-n in particular, and the overall performance of system 100 in general. Accordingly, a user may realize enhanced products and services.

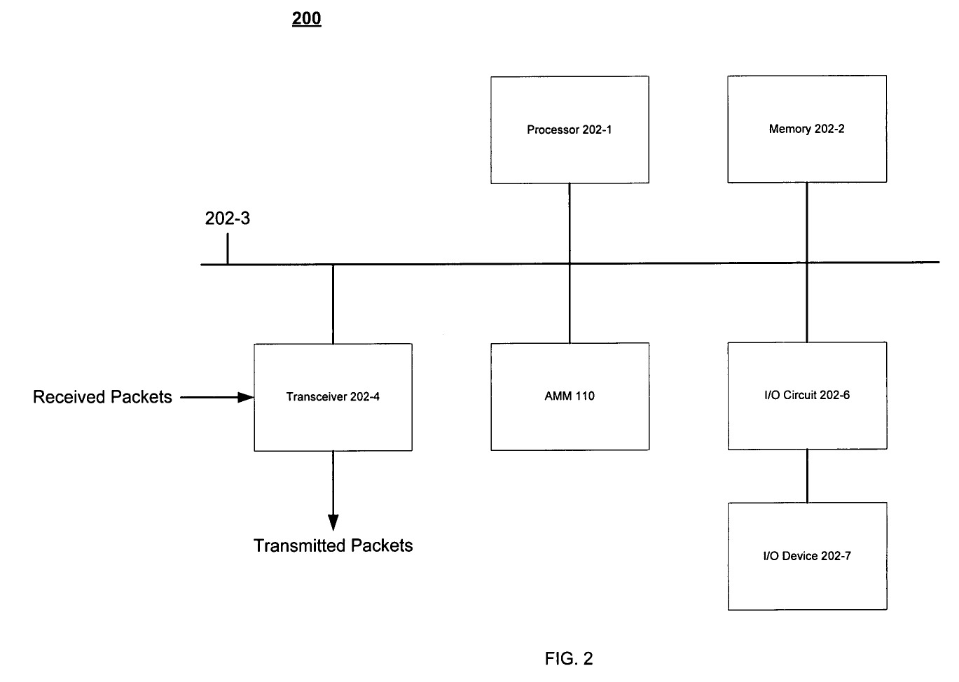

FIG. 2 illustrates a block diagram of a node in accordance with one embodiment of the system. FIG. 2 illustrates a block diagram of a node 200 suitable for use with system 100 as described with reference to FIG. 1, such as one or more nodes 102-1-n, for example. In one embodiment, for example, node 200 may be representative of mobile devices 102-1, 102-2. The embodiments are not limited, however, to the example given in FIG. 2.

As shown in FIG. 2, node 200 may comprise multiple elements, such as elements 202-1-p. Each of elements 202-1-p or sub-elements of 202-1-p may comprise, or be implemented as, one or more circuits, components, registers, processors, software subroutines, modules, or any combination thereof, as desired for a given set of design or performance constraints. Although FIG. 2 shows a limited number of elements by way of example, it can be appreciated that more or less elements may be used in element 202-1-p as desired for a given implementation. The embodiments are not limited in this context.

In one embodiment, node 200 may include an element 202-1. In one embodiment, for example, element 202-1 may comprise a processor. For example, processor 202-1 may be implemented as a general purpose processor, such as a general purpose processor made by Intel® Corporation, Santa Clara, Calif. In another example, processor 202-1 may include a dedicated processor, such as a controller, microcontroller, embedded processor, a digital signal processor (DSP), a field programmable gate array (FPGA), a programmable logic device (PLD), a network processor, an I/O processor, and so forth. When node 200 is implemented for mobile device 102-2, such as a notebook computer, processor 202-1 may comprise a general purpose processor, such as an Intel Pentium® M processor, for example. When node 200 is implemented for mobile device 102-1, such as a cellular telephone, processor 202-1 may be implemented as a processor more appropriate for the form factor, processing performance, heat tolerances, power resources, application types, and other design constraints suitable for such devices. For example, processor 202-1 may comprise an Intel Personal Communications Architecture (PCA) processor based on an Intel XScale® (XSC) microarchitecture, such as an Intel PXA255, PXA 26x, PXA 27x, and so forth. The embodiments are not limited in this context.

In one embodiment, node 200 may include an element 202-2. In one embodiment, for example, element 202-2 may comprise memory. Memory 202-2 may include any machine-readable or computer-readable media capable of storing data, including both volatile and non-volatile memory. For example, memory 202-2 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 202-2 may be included on the same integrated circuit as processor 202-1, or alternatively some portion or all of memory 202-2 may be disposed on an integrated circuit or other medium, for example a hard disk drive, that is external to the integrated circuit of processor 202-1. The embodiments are not limited in this context.

In one embodiment, node 200 may include an element 202-4. In one embodiment, for example, element 202-4 may comprise a wireless or radio transceiver. Wireless transceiver 202-4 may comprise any transceiver suitable for a particular wireless system. In one embodiment, the transceiver may be implemented as part of a chip set (not shown) associated with processor 202-1. As used herein, the term “transceiver” may be used in a very general sense to include a transmitter, a receiver, or a combination of both. The embodiments are not limited in this context.

In one embodiment, node 200 may include AMM 110. In one embodiment, for example, AMM 110 may be representative of AMM 110a when implemented as part of mobile device 102-2, and AMM 110b when implemented as part of mobile device 102-1, respectively. The embodiments are not limited in this context.

In general operation, AMM 110 may manage authentication operations for mobile device 102-2. For example, AMM 110 may initiate a PAN connection between mobile device 102-2 and other wireless devices, such as mobile device 102-1. In one embodiment, for example, AMM 110 may form a secure connection with mobile device 102-1 by performing discovery and authentication operations on behalf of mobile device 102-1 in accordance with a given wireless protocol, security technique, and underlying transport layer. Once a secure connection has been established between mobile devices 102-1, 102-2, AMM 110 may retrieve subscriber information from SIM 112 of mobile device 102-1. The embodiments are not limited in this context.

In one embodiment, node 200 may include elements 202-6, 202-7. In one embodiment, for example, element 202-6 may comprise an I/O circuit, and element 202-7 may comprise an I/O device. I/O circuit 202-6 may control a number of I/O devices 202-7. Examples of I/O circuit 202-6 may include a disc controller, video controller, audio controller, keyboard controller, mouse controller, and so forth. Examples of I/O device 202-7 may include a display, monitor, keyboard, keypad, mouse, touchpad, touch screen, pointer, speakers, smart card, SIM card, and so forth. The embodiments are not limited in this context.

In one embodiment, the various elements 202-1-p may be connected by bus 202-3. When node 200 is implemented as part of mobile device 102-2, bus 202-3 may comprise a system bus such as a peripheral component interconnect (PCI) bus defined by a PCI Local Bus Specification. The embodiments are not limited in this context.

In general operation, mobile device 102-2 may attempt to access a WLAN via fixed device 102-3 via wireless communications medium 106-2. Mobile device 102-2 may perform discovery operations to discovery signals received from one or more nearby AP, such as fixed device 102-3. Mobile device 102-2 may perform the discovery operations in accordance with a number of different WLAN protocols, such as one or more of the IEEE 802.11 series of protocols, for example. Once mobile device 102-2 discovers fixed device 102-3, mobile device 102-2 may send a request to fixed device 102-3 to initiate a secure data connection with fixed device 102-3. Establishing a secure connection between mobile device 102-2 and fixed device 102-3 may involve certain authentication operations. For example, mobile device 102-2 may need to identify itself to fixed station 102-3, select a security protocol or algorithm, receive a private encryption key, and so forth. To accomplish some authentication operations, mobile device 102-2 may need to provide subscriber information to fixed device 102-3. In one embodiment, for example, mobile device 102-2 may retrieve the subscriber information from SIM 112 of mobile device 102-1.

To retrieve the subscriber information, mobile device 102-2 may establish a PAN connection with mobile device 102-1. In one embodiment, for example, the connection may be a secure PAN connection. To form the secure PAN connection, a set of discovery and authentication operations may need to be performed. For example, assume discovery operations are performed in accordance with the Bluetooth Specification. During Bluetooth discovery operations, two or more Bluetooth devices may agree to communicate with one another. This may occur by placing one of the devices in a discoverable mode. When in discoverable mode, a Bluetooth device may be discoverable by other Bluetooth devices. The other Bluetooth device may be placed in a discovery mode. When in discovery mode, a device may discover other Bluetooth devices. The device in discovery mode searches for devices in discoverable mode, and when located, performs authentication operations to authenticate the identity of the discovered device. When authentication operations are completed, the two devices form a trusted relationship or trusted pair. When one device recognizes another device in an established trusted pair, each device automatically accepts subsequent communications, bypassing the discovery and authentication process that normally occurs during Bluetooth interactions.

Once a secure PAN connection has been established between mobile devices 102-1, 102-2, mobile device 102-2 may retrieve the subscriber information from SIM 112 of mobile device 102-1. Mobile device 102-2 may use AMM 110 to retrieve the subscriber information in a manner transparent to mobile devices 102-1, 102-2. In other words, AMM 110 may attempt to redirect certain commands from mobile device 102-2 to mobile device 102-1, and redirect responses from mobile device 102-1 to mobile device 102-2, in a manner that appears as if mobile device 102-2 is retrieving the subscriber information from a SIM located with mobile device 102-2.

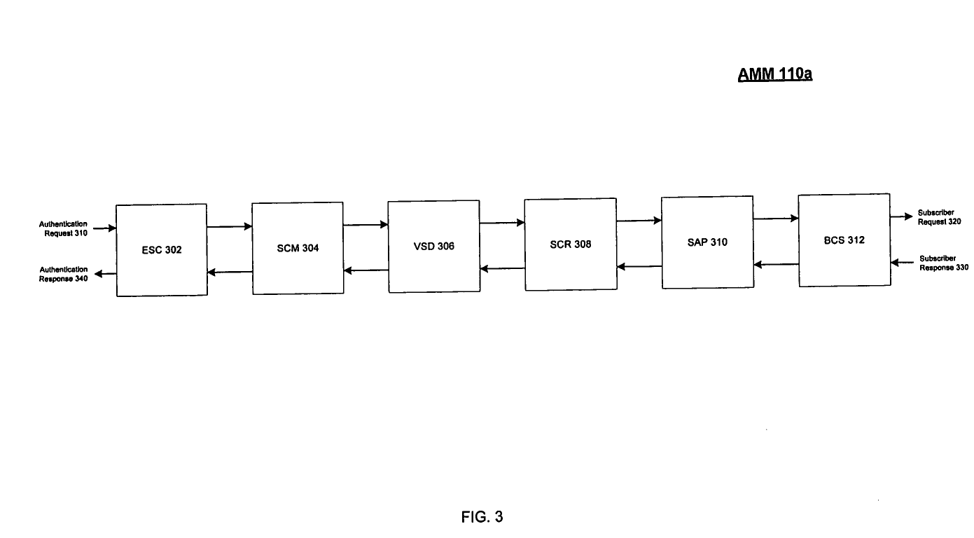

In one embodiment, AMM 110 may be arranged to communicate information using a number of different protocols, typically arranged in a protocol stack. For example, AMM 110 may be arranged to communicate with other wireless devices using an IEEE protocol titled “Extensible Authentication Protocol (EAP),” RFC 3748, June 2004 (“EAP Specification”). More particularly, AMM 110 may be arranged to communicate with a variant of EAP referred to as EAP-SIM. EAP-SIM is an implementation of an authentication technique of EAP used in GSM-based cellular telephone networks and associated devices. EAP-SIM provides mutual authentication of a client device with a network, and a network with the client device, to ensure that only valid user devices gain access to the network. EAP-SIM is designed for use with a SIM smart card (e.g., SIM 112) containing subscriber information that can be used in various network operations, such as authentication operations, accounting operations, billing operations, encryption operations, and so forth. AMM 110 may be described in more detail with reference to FIG. 3.

FIG. 3 illustrates one embodiment of an AMM. FIG. 3 may illustrate a more detailed block diagram of AMM 110. More particularly, FIG. 3 may illustrate a more detailed block diagram of AMM 110 when implemented as part of mobile device 102-2, such as AMM 110a. The embodiments are not limited, however, to the example given in FIG. 3.

In one embodiment, AMM 110a may include an EAP-SIM client (ESC) 302. ESC 302 may comprise an application that implements the EAP-SIM protocol and interacts with SIM 112 for WLAN authentication. The embodiments are not limited in this context.

In one embodiment, AMM 110a may include a smartcard resource manager (SCM) 304. SCM 304 may comprise an application that manages access to various smart cards for a device, such as mobile device 102-2. For example, SCM 304 may read and write data between an operating system and a SIM. SCM 304 may comprise, for example, a smart card resource manager made by Microsoft Corporation, Redmond, Wash. The embodiments are not limited in this context.

In one embodiment, AMM 110a may include a virtual SIM driver (VSD) 306. VSD 306 may comprise an application that interfaces with SCM 304 to retrieve subscriber information from a device other than mobile device 102-2. VSD 306 may register with SCM 304 using various SCM application specific interface (API) commands thereby making VSD 306 available to ESC 302. Since SCM 304 includes support for accessing a SIM, VSD 306 may be accessed by ESC 302 to retrieve subscriber information from SIM 112 of mobile device 102-1 using the same set of commands normally used to access a SIM implemented locally with mobile device 102-2 (e.g., I/O device 202-7). This may provide transparent access to SIM 112 from the perspective of ESC 302, thereby potentially reducing the number of modifications needed for legacy devices. The embodiments are not limited in this respect.

In one embodiment, AMM 110a may include a SIM command redirector (SCR) 308. SCR 308 may comprise an application to redirect commands from VSD 306 to mobile device 102-1 using a PAN connection. For example, SCR 308 may redirect application protocol data unit (APDU) commands typically communicated between a smart card and a smart card reader. For example, ESC 302 operating as a smart card reader may generate a command APDU for SIM 112, and SIM 112 operating as a smart card may generate a response APDU in response to the command APDU. SCR 308 may also maintain various needed states, and operates as a bridge between VSD 306 and the PAN protocols. The embodiments are not limited in this context.

In one embodiment, AMM 110a may include a SIM access profile client (SAP) 310. SAP 310 may comprise an application to operate as a transport interface to transport the APDU on behalf of SRM 304. The embodiments are not limited in this context.

In one embodiment, AMM 110a may include a Bluetooth core stack (BCS) 312. BCS 312 may comprise an application to provide core Bluetooth operations, such as serial port profiles (SPP), Bluetooth service discovery, L2cap operations, and other core features to support an SAP client. The embodiments are not limited in this context.

In general operation, mobile device 102-2 may attempt to access network services provided by network 108 via fixed device 102-3. Mobile device 102-2 may send a request to access network 108 to fixed device 102-3. Fixed device 102-3 may pass the request to authentication server 102-4. Authentication server 102-4 may comprise, for example, an AAA/RADIUS authentication server. Authentication server 102-4 may send a response to mobile device 102-2 via fixed device 102-3. The response may request subscriber information from a SIM, such as SIM 112 of mobile device 102-1. Mobile device 102-2 may use AMM 110a to retrieve the subscriber information from SIM 112 of mobile device 102-1 as described further below. Mobile device 102-2 may then forward the subscriber information to authentication server 102-4 via fixed device 102-3. The subscriber information may be in the form of GSM triplets, for example. Authentication server 102-4 may use the subscriber information to access a GSM authentication center via a GSM/MAP/SS7 gateway (not shown) over a SS7 network, for example. The GSM authentication center may attempt to authenticate mobile device 102-2 using the GSM triplets. If SIM 112 and the EAP-SIM client software are able to validate the GSM triplets, authentication server 102-4 sends a message to fixed device 102-3 to grant network access to mobile device 102-2. Fixed device 102-3 connects mobile device 102-2 to network 108 and forwards accounting information to authentication server 102-4 to indicate that the connection has been completed. The accounting information may be incorporated into a database for billing applications.

Mobile device 102-2 may use AMM 110a to retrieve the subscriber information from SIM 112 of mobile device 102-1. Referring again to FIG. 3, ESC 302 of AMM 110 may receive an authentication request 318 from authentication server 102-4. ESC 302 may generate a command APDU to retrieve subscriber information from a SIM. ESC 302 may attempt to retrieve the subscriber information using the same commands used when a SIM is located as part of mobile device 102-2, such as via I/O circuit 202-6 and I/O device 202-7. The command APDU from ESC 302 may be received by SCM 304. SCM 304 may manage a SIM, such as reading and writing data between an operating system and the SIM. Since VSD 306 is registered with SCM 304 using the SCM 304 API interface, SCM 304 will send the command APDU to VSD 306 rather than I/O circuit 202-6. In other words, VSD 306 may be used as a transparent driver interface between ESC 302 and SIM 112 located on another device. VSD 306 may send the command APDU to SCR 308. SCR 308 may redirect the command APDU from VSD 306 to mobile device 102-1 using a Bluetooth interface for mobile device 102-2, such as a Bluetooth connection established using SAP 310 and BCS 312. Mobile device 102-2 may transmit a subscriber request 320 with the command APDU to mobile device 102-1.

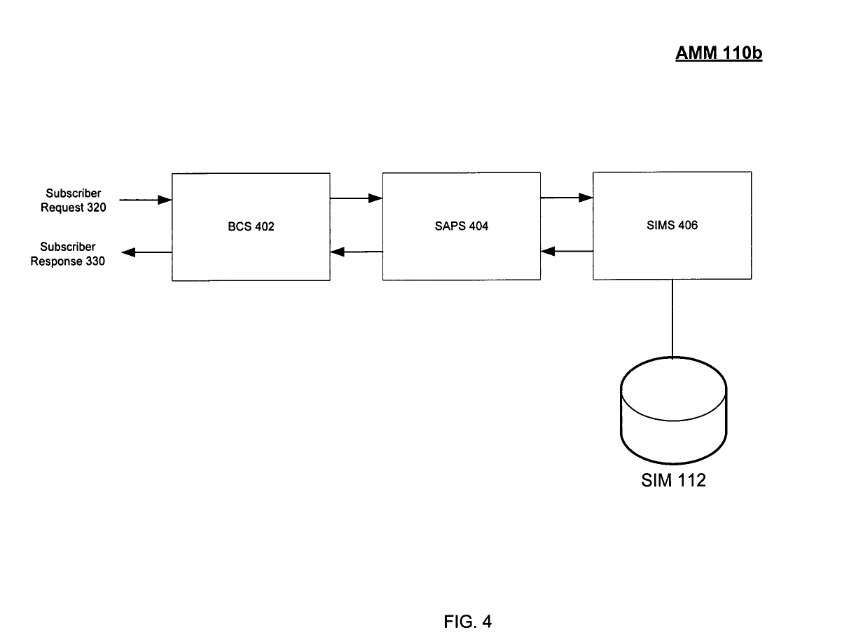

Once mobile device 102-1 receives the command APDU from mobile device 102-2, the command APDU may be processed by the Bluetooth interface of mobile device 102-1. Mobile device 102-1 may use AMM 110b to assist in retrieving the requested subscriber information from SIM 112. AMM 110b may be described in more detail with reference to FIG. 4.

FIG. 4 illustrates one embodiment of an AMM. FIG. 4 may illustrate a more detailed block diagram of AMM 110. More particularly, FIG. 4 may illustrate a more detailed block diagram of AMM 110 when implemented as part of mobile device 102-1, such as AMM 110b. The embodiments are not limited, however, to the example given in FIG. 4.

In one embodiment, AMM 110b may include a BCS 402. BCS 402 may be similar to BCS 312 described with reference to FIG. 3. BCS 402 may perform core Bluetooth operations for mobile device 102-1. For example, BCS 402 may receive subscriber request 320 from mobile device 102-2 over the secure Bluetooth connection established between mobile devices 102-1, 102-2. The embodiments are not limited in this context.

In one embodiment, AMM 110b may include a SAP server (SAPS) 404. SAPS 404 may be similar to SAP 310 described with reference to FIG. 3. SAPS 404 may receive and process APDU and SIM commands over the secure Bluetooth connection. For example, SAPS 404 may receive subscriber request 320 from BCS 402, and retrieve the command APDU from subscriber request 320. The embodiments are not limited in this context.

In one embodiment, AMM 110b may include a SIM server (SIMS) 406. SIMS 406 may be arranged to interface with SIM 112. SIMS 406 may pass the commands and APDU from SAPS 404 to SIM 112. SIMS 406 may receive responses (e.g., subscriber information) from SIM 112 and passes the response to SAPS 404. The embodiments are not limited in this context.

In general operation, BCS 402 of mobile device 102-1 may receive subscriber request 320 from mobile device 102-2. BCS 402 may pass subscriber request 320 to SAPS 404. SAPS 404 may in turn pass the request to SIMS 406. SIMS 406 may retrieve subscriber information from SIM 112 in response to the command APDU embedded with subscriber request 320. SIMS 406 may forward the subscriber information to SAPS 404, which in turn passes the subscriber information to BCS 402. BCS 402 may send the subscriber information as part of subscriber response 330 over the secure Bluetooth connection to mobile device 102-2. Subscriber response 330 may comprise, for example, a response APDU generated by SIM 112 or some other element of AMM 110b. The embodiments are not limited in this context.

Referring again to FIG. 3, BCS 312 of AMM 110a may receive subscriber response 330 from mobile device 102-1. BCS 312 may pass subscriber response 330 to SAP 310, which in turn passes it to SCR 308. SCR 308 may redirect subscriber response 330 to VSD 306. VSD 306 may retrieve the response APDU with the subscriber information, and forward the subscriber information to ESC 302 via SCM 304. ESC 302 may then generate an authentication response 340 to authentication request 318. AMM 110a may forward authentication response 340 to fixed device 102-3 via transceiver 202-4. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

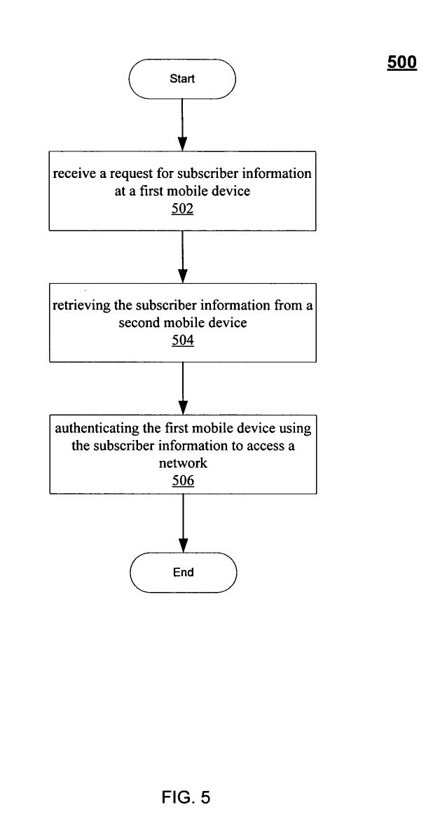

FIG. 5 illustrates a logic diagram in accordance with one embodiment. FIG. 5 illustrates a logic flow 500. Logic flow 500 may be representative of the operations executed by one or more structure described herein, such as system 100, node 200, and AMM 110a, 110b. As shown in logic flow 500, a request for subscriber information may be received at a first mobile device at block 502. The request may be received from a fixed device, such as an AP for a WLAN, on behalf of an authentication server (e.g., authentication server 102-4). The embodiments are not limited in this context.

In one embodiment, the subscriber information may be retrieved from a second mobile device at block 504. A secure personal area network connection may be formed between the first mobile device and the second mobile device to retrieve the subscriber information. The subscriber information may be retrieved from the second mobile device using APDU commands in accordance with an EAS-SIM technique. The embodiments are not limited in this context.

The first mobile device may be authenticated using said subscriber information to access a network at block 506. A wireless local area network connection may be formed between the first mobile device and a third device to authenticate the first mobile device. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware, such as a circuit, an application specific integrated circuit (ASIC), Programmable Logic Device (PLD) or digital signal processor (DSP), and so forth. In yet another example, an embodiment may be implemented by any combination of programmed general-purpose computer components and custom hardware components. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising an authentication management module to manage authentication of a first mobile device to access a wireless local area network using subscriber information stored on a second mobile device.

2. The apparatus of claim 1, said first mobile device to form a secure personal area network connection with said second mobile device to retrieve said subscriber information from said second mobile device.

3. The apparatus of claim 1, said first mobile device to form a wireless local area network connection between said first mobile device and a wireless access point to authenticate said first mobile device.

4. The apparatus of claim 1, said first mobile device to retrieve said subscriber information from said second mobile device using one or more application protocol data unit commands in accordance with an extensible authentication protocol.

5. The apparatus of claim 1, said second mobile device to comprise a cellular telephone, said cellular telephone to include a subscriber identity module to store said subscriber information.

6. The apparatus of claim 1, comprising:
an extensible authentication protocol subscriber identity module client to generate a command application protocol data unit;
a smartcard resource manager to couple to said extensible authentication protocol subscriber identity module client, said smartcard resource manager to pass said command application protocol data unit to a registered subscriber identity module card;
a virtual subscriber identity module driver to couple to said smartcard resource manager, said virtual subscriber identity module driver to intercept said command application protocol data unit; and
a subscriber identity module command redirector to couple to said virtual subscriber identity module driver, said subscriber identity module command redirector to redirect said intercepted command application protocol data unit to a first personal area network interface for said first mobile device.

7. The apparatus of claim 6, comprising:
a second personal area network interface for said second mobile device to receive said command application protocol data unit from said first mobile device; and
a subscriber identity module access profile server to couple to said second personal area network interface, said subscriber identity module access profile server to direct said command application protocol data unit to a subscriber identity module server; and
said subscriber identity module server to interface with a subscriber identity module to retrieve said subscriber information in response to said command application protocol data unit.

8. A system comprising:
an antenna;
a transceiver to couple to said antenna; and
an authentication management module to couple to said transceiver, said authentication management module to manage authentication of a first mobile device to access a network using subscriber information stored on a second mobile device.

9. The system of claim 8, said first mobile device to form a secure personal area network connection with said second mobile device to retrieve said subscriber information from said second mobile device.

10. The system of claim 8, said first mobile device to form a wireless local area network connection between said first mobile device and a wireless access point to authenticate said first mobile device.

11. The system of claim 8, said first mobile device to retrieve said subscriber information from said second mobile device using one or more application protocol data unit commands in accordance with an extensible authentication protocol.

12. The system of claim 8, said second mobile device to comprise a cellular telephone, said cellular telephone to include a subscriber identity module to store said subscriber information.

13. The system of claim 8, comprising:
an extensible authentication protocol subscriber identity module client to generate a command application protocol data unit;
a smartcard resource manager to couple to said extensible authentication protocol subscriber identity module client, said smartcard resource manager to pass said command application protocol data unit to a registered subscriber identity module card;
a virtual subscriber identity module driver to couple to said smartcard resource manager, said virtual subscriber identity module driver to intercept said command application protocol data unit; and
a subscriber identity module command redirector to couple to said virtual subscriber identity module driver, said subscriber identity module command redirector to redirect said intercepted command application protocol data unit to a first personal area network interface for said first mobile device.

14. The system of claim 13, comprising:
a second personal area network interface for said second mobile device to receive said command application protocol data unit from said first mobile device; and
a subscriber identity module access profile server to couple to said second personal area network interface, said subscriber identity module access profile server to direct said command application protocol data unit to a subscriber identity module server; and said subscriber identity module server to interface with a subscriber identity module to retrieve said subscriber information in response to said command application protocol data unit.

15. A method, comprising:
receiving a request for subscriber information at a first mobile device;
retrieving said subscriber information from a second mobile device; and
authenticating said first mobile device using said subscriber information to access a network.

16. The method of claim 15, comprising forming a wireless local area network connection between said first mobile device and a third device to authenticate said first mobile device.

17. The method of claim 15, comprising forming a secure personal area network connection between said first mobile device and said second mobile device to retrieve said subscriber information.

18. The method of claim 15, comprising retrieving said subscriber information from said second mobile device using application protocol data unit commands in accordance with an extensible authentication protocol.

19. An article comprising a machine-readable storage medium containing instructions that if executed enable a system to receive a request for subscriber information at a first mobile device, retrieve said subscriber information from a second mobile device, and authenticate said first mobile device using said subscriber information to access a network.

20. The article of claim 19, further comprising instructions that if executed enable the system to form a wireless local area network connection between said first mobile device and a third device to authenticate said first mobile device.

21. The article of claim 19, further comprising instructions that if executed enable the system to form a personal area network connection between said first mobile device and said second mobile device to retrieve said subscriber information.

22. The article of claim 19, further comprising instructions that if executed enable the system to retrieve said subscriber information from said second mobile device using application protocol data unit commands in accordance with an extensible authentication protocol.
